(19) United States
(12) Patent Application Publication
(10) Pub. No.: US 2025/0361765 A1
(43) Pub. Date: Nov. 27, 2025

(54) ASSEMBLED DOOR AND WINDOW FRAME PROFILE AND MANUFACTURING PROCESS THEREOF

(71) Applicant: Guiyu CHANG, Shanghai (CN)

(72) Inventors: Jingxuan YANG, Shanghai (CN); Guiyu CHANG, Shanghai (CN)

(21) Appl. No.: 19/082,294

(22) Filed: Mar. 18, 2025

Related U.S. Application Data
(63) Continuation of application No. PCT/CN2024/114085, filed on Aug. 23, 2024.

(30) Foreign Application Priority Data
May 27, 2024 (CN) 202410665318.5
May 27, 2024 (CN) 202421178043.4
Aug. 1, 2024 (CN) 202411049530.5
Aug. 1, 2024 (CN) 202421853107.6

(51) Int. Cl. E06B 3/263

(52) U.S. Cl. CPC E06B 3/26305; E06B 2003/26312

(57) ABSTRACT

An assembled door and window frame profile and a manufacturing process thereof include a profile frame connected to a heat insulating strip, the profile frame includes a main frame and a fitting body, the fitting body is in snap-in connection with the heat insulating strip, and the fitting body is configured to be detachably connected to the main frame.

### CROSS-REFERENCE TO RELATED APPLICATION

This application is a continuation of PCT application serial no. PCT/CN2024/114085, filed on Aug. 23, 2024, which claims the priority and benefit of Chinese patent application serial no. 202410665318.5, filed on May 27, 2024, Chinese patent application serial no. 202421178043.4, filed on May 27, 2024, Chinese patent application serial no. 202411049530.5, filed on Aug. 1, 2024, and Chinese patent application serial no. 202421853107.6, filed on Aug. 1, 2024. The entireties of PCT application serial no. PCT/CN2024/114085, Chinese patent application serial no. 202410665318.5, Chinese patent application serial no. 202421178043.4, Chinese patent application serial no. 202411049530.5, and Chinese patent application serial no. 202421853107.6 are hereby incorporated by reference herein and made a part of this specification.

### TECHNICAL FIELD

The present disclosure relates to the field of architectural profiles, and in particular, to an assembled door and window frame profile.

### BACKGROUND ART

Frame materials for metal doors and windows are generally assembly materials of aluminum alloy, cold-rolled steel and hot-rolled steel. A plurality of profiles are joined and fixed into rectangular and irregular shapes for use in the periphery of a building, so that sufficient lighting may be obtained indoors and an indoor environment with warm winter and cool summer may be formed.

In the related art, a door and window frame includes a frame body, which includes a plurality of profile frames and fixed frames that overlap each other, where each of the profile frames is a separate profile. Heat insulating strips are provided between each two adjacent profile frames. The profile frame is usually integrally molded by cold pressing metal strips, and the heat insulating strip is connected to the profile frame in a snap-in manner and is thus also configured with a groove for the snap-in connection with the heat insulating strip.

According to the use of the profile frames and the assembly requirements, it is more difficult for the one-time cold pressing process in terms of mold design, materials molding, or the like, which greatly increases the related manufacturing cost.

### SUMMARY

In order to solve the above problems, the present disclosure provides an assembled door and window frame profile and a manufacturing process thereof.

The assembled door and window frame provided by the present disclosure adopts the following technical solutions.

An assembled door and window frame profile includes a profile frame connected to a heat insulating strip, where the profile frame includes a main frame and a fitting body, the fitting body is in snap-in connection with the heat insulating strip, and the fitting body is configured to be detachably connected to the main frame.

By adopting the above solution, an original complex structure of an integrated profile frame is exploded. The processing difficulty of a single main frame and a single fitting body is reduced, and the fitting of the heat insulating strip and the fitting body is more convenient than that of the heat insulating strip and the profile frame, so that the manufacturing and processing costs are reduced.

Optionally, the heat insulating strip is provided with a fitting projection, the fitting body is configured with a fitting groove, and the fitting projection is configured to be embedded in the fitting groove and abut against a wall of the fitting groove.

The snap-in connection of the fitting body and the heat insulating strip is realized by the cooperation of the fitting projection and the fitting groove.

Optionally, the fitting body is provided with two fitting wings, the fitting groove is formed between the two fitting wings, the two fitting wings are configured to be mutually inclined in opposite directions with respect to an extension direction of the fitting body before the fitting projection enters the fitting groove, and the two fitting wings are configured to be mutually parallel with respect to the extension direction of the fitting body after the fitting projection enters the fitting groove.

By adopting the above solution, in the process of connecting the heat insulating strip and the fitting body, the fitting wings are flared to facilitate the smooth entry of the fitting projection of the heat insulating strip into the space formed by the two fitting wings, and then the fitting wings are forced to abut against and clamp the fitting projection due to a plastic deformation characteristic of the material itself, thereby completing the connection between the heat insulating strip and the fitting body.

Optionally, the main frame and the fitting body are configured to be in snap-in connection with each other, the main frame is configured with a mounting groove, the fitting body is provided with a mounting projection, and the mounting projection is configured to be embedded in the mounting groove and abut against a wall of the mounting groove.

Optionally, the fitting body is provided with a chamfer, so that a solder groove is formed between the fitting body and the main frame through the chamfer after the mounting projection enters the mounting groove.

By adopting the above solution, the main frame and the fitting body may be selectively reinforced by means of laser micro welding according to the differences in use environments or functional requirements of the products. The solder groove is configured to store solder, thereby reducing the impact on the overall flatness of the profile frame after a welding seam is shaped.

Optionally, the fitting body is provided with a plurality of blind holes, openings of the plurality of blind holes are positioned on one side of the fitting body away from the two fitting wings, bottoms of the plurality of blind holes are positioned in the two fitting wings, a reinforcing rod is inserted into each of the plurality of blind holes, a hardness of the reinforcing rod is greater than a hardness of the fitting body and a hardness of the two fitting wings, the plurality of blind holes are arranged in a length direction of the fitting body, ends of the plurality of reinforcing rods arranged in the length direction of the fitting body away from the bottoms of the plurality of blind holes are fixedly connected to one connecting rod, a length direction of the connecting rod is consistent with the length direction of the fitting body, a groove for the connecting rod is formed in the main frame, a length direction of the groove for the connecting rod is consistent with a length direction of the main frame, the connecting rod is positioned in the groove for the connecting rod, and the connecting rod is configured to abut against a wall of the groove for the connecting rod.

By adopting the above solution, when the connecting rod is inserted into the groove for the connecting rod, the connecting rod generates a contact force against the wall of the groove for the connecting rod due to the deformable potential energy of the fitting wings relative to the fitting body with the direction of the contact force towards the mounting groove, and the connecting rod receives a reaction force from the groove for the connecting rod so that each reinforcing rod has a tendency to swing towards the fitting groove, so the reinforcing rod has a force against deformation on the fitting wings, thereby improving the clamping stability of the fitting wings 222 to the fitting projection in an assembled state.

A manufacturing process of the above assembled door and window frame profile provided by the present application adopts the following technical solutions.

A manufacturing process of the assembled door and window frame profile includes following steps in sequence:
S1: manufacturing the main frame and the fitting body respectively, where the fitting body is integrally formed with the two fitting wings, and in a natural state, the two fitting wings on the fitting body are mutually inclined in opposite directions with respect to the extension direction of the fitting body,
S2: placing the fitting projection of the heat insulating strip between the two fitting wings, and pressurizing the two fitting wings by using a mounting equipment so that the two fitting wings tightly clamp the fitting projection,
S3: connecting the fitting body and the main frame by using the mounting equipment, and
S4: removing the main frame, the fitting body and the heat insulating strip assembled from the mounting equipment.

Optionally, the S2 and S3 are carried out simultaneously on the mounting equipment, the mounting equipment includes a stationary shelf, a movable shelf and a rolling mechanism, the rolling mechanism is positioned on the stationary shelf and includes a plurality of rolling wheels, the plurality of rolling wheels are rotatably connected to the stationary shelf, the main frame is placed on the stationary shelf, an axis of each of the plurality of rolling wheels is perpendicular to a length direction of the main frame, the movable shelf is slidable relative to the stationary shelf with a sliding direction being consistent with the length direction of the main frame, the movable shelf is configured to apply a thrust on the fitting body and the heat insulating strip as the movable shelf moves, so as to move the fitting body and the heat insulating strip, and during the movement of the fitting body and the heat insulating strip, the two fitting wings abut against surfaces of the plurality of rolling wheels in a rolling manner.

By adopting the above solution, in the process of pushing the fitting body and the heat insulating strip to the stationary shelf, the rolling wheels abut against the fitting wings in a rolling manner, so as to generate pressure on the fitting wings, promoting a plastic deformation of the fitting wings relative to the fitting body, thereby improving the clamping tightness of the fitting wings to the heat insulating strip.

Optionally, the stationary shelf is provided with a drive motor, the drive motor is configured to control the rotation of one or more of the plurality of rolling wheels, the rolling mechanism further includes an unloading assembly, the unloading assembly includes a movable rack, a plurality of unloading wheels are rotatably provided on the movable rack, and the movable rack is movably connected to the stationary shelf with a moving direction being close to or away from the main frame, each of the plurality of unloading wheels corresponds to a respective one of the plurality of rolling wheels, a universal coupling is connected between an axle of each of the plurality of unloading wheels and an axle of the respective one of the plurality of rolling wheels, and the unloading assembly further includes a control source for controlling the movement of the movable rack.

By adopting the above solution, in the process of moving the fitting body relative to the main frame, the unloading wheels are not in contact with the main frame. After the main frame and the fitting body are docked, the movable rack moves close to the main frame such that each unloading wheel abuts against the main frame. At this time, when the rolling wheel rotates again, each unloading wheel also rotates accordingly, so as to generate a friction for moving forward on the main frame to move the main frame, thereby removing the assembled main frame, fitting body and heat insulating strip from the stationary shelf together.

Optionally, the S4 further includes welding the main frame and the fitting body, the mounting equipment further includes a laser welding torch, and the laser welding torch is fixed relative to the stationary shelf and is positioned at one end of the stationary shelf close to the movable shelf.

By adopting the above solution, according to the manufacturing requirements of the product, by using the movement trend of the main frame and the fitting body together during unloading, the laser welding torch is activated to weld the main frame and the fitting body, thereby realizing the reinforcement by welding.

In summary, the present application includes at least one of the following beneficial technical effects.

1. By dividing the profile frame into the main frame and the fitting body, the original complex structure of the integrated profile frame is exploded. The processing difficulty of a single main frame and a single fitting body is reduced, and the fitting of the heat insolating strip and the fitting body is more convenient than that of the heat insulating strip and the profile frame, so that the manufacturing and processing costs are reduced.

2. Through the fitting wings, in the process of connecting the heat insulating strip and the fitting body, the fitting wings are flared to facilitate the smooth entry of the fitting projection of the heat insulating strip into the space formed by the two fitting wings, and then the fitting wings are forced to abut against and clamp the fitting projection due to the plastic deformation characteristic of the material itself, thereby completing the connection between the heat insulating strip and the fitting body.

3. Through the mounting equipment, the clamping of the heat insulating strip by the fitting wings of the fitting body, the snap-in connection of the fitting body and the main frame, and the welding connection of the main frame and the fitting body are completed in turn, which is convenient in operation and highly efficient in production.

### BRIEF DESCRIPTION OF THE DRAWINGS

FIG. 1 is a schematic cross-sectional view showing an assembled door and window frame profile according to Embodiment 1 of the present application.

FIG. 2 is a schematic diagram showing a fitting structure of a fitting body and a heat insulation strip according to Embodiment 1 of the present application.

FIG. 3 is a schematic diagram showing a fitting structure of the fitting body and a main frame according to Embodiment 1 of the present application.

FIG. 4 is a schematic cross-sectional view showing the assembled main frame and fitting body according to Embodiment 2 of the present application.

FIG. 5 is a schematic diagram showing the structure of a connecting rod and a reinforcing rod according to Embodiment 2 of the present application.

FIG. 6 is a schematic flowchart showing a manufacturing process of the assembled door and window frame profile according to an embodiment of the present application.

FIG. 7 is atop view ofa mounting equipment according to an embodiment of the present application.

FIG. 8 is a section view of a rolling mechanism and an unloading assembly according to an embodiment of the present application.

### DETAILED DESCRIPTION

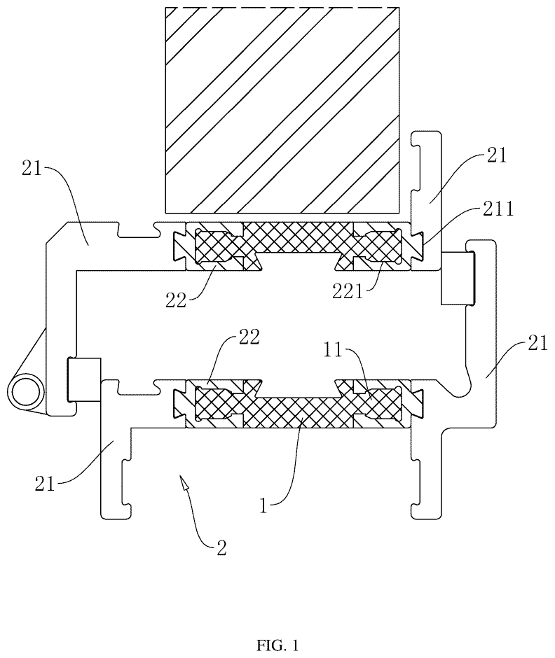

The present application will be further described in detail below with reference to FIGS. 1 to 8.

### Embodiment 1

The present embodiment discloses an assembled door and window frame profile. As shown in FIG. 1, the assembled door and window frame profile includes a profile frame 2 which is divided into multiple pieces, including a main frame 21 and a fitting body 22 that are detachably connected to each other and both made of aluminum alloy profiles. The fitting body 22 is configured to indirectly connect a heat insulating strip 1 and the profile frame 2.

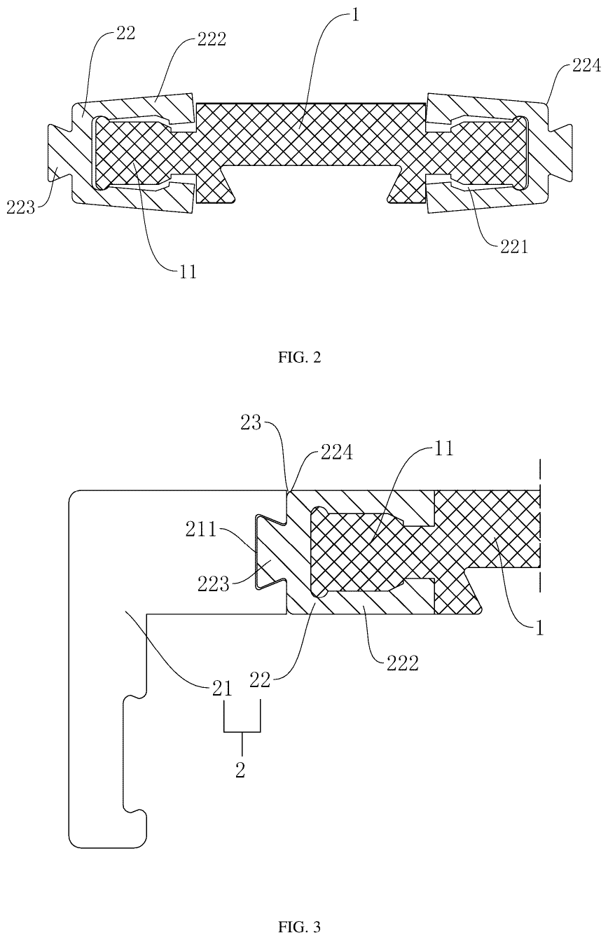

As shown in FIGS. 1 and 2, taking a window as an example in the present embodiment, the profile frames 2 of a door leaf and a door frame each include two main frames 21 overlapping each other, and the heat insulating strip 1 is positioned between the two main frames 21. The connection between the heat insulating strip 1 and the fitting body 22 and the connection between the fitting body 22 and the main frame 21 are both snap-in connection. The fitting body 22 is integrally formed with two fitting wings 222 on one and the same side, and a space formed between the two fitting wings 222 is a fitting groove 221. Two opposite sides of the heat insulating strip 1 are each integrally formed with a fitting projection 11. In a natural state, a cross-sectional shape of the fitting projection 11 coincides with a cross-sectional shape of the fitting groove 221, and the fitting groove 221 at one fitting body 22 is configured to accommodate one fitting projection 11, thereby realizing the fixation of the fitting body 22 and the heat insulating strip 1.

As shown in FIG. 2, in the process of assembling the fitting body 22 and the heat insulating strip 1, before the fitting projection 11 enters the fitting groove 221, the two fitting wings 222 are mutually inclined in opposite directions with respect to an extension direction of the fitting body 22, such that an opening of the fitting groove 221 is flaring, which facilitates the fitting projection 11 to enter the fitting groove 221 between the two fitting wings 222 more smoothly. After the fitting projection 11 enters the fitting groove 221, the fitting wings 222 are plastically bent by opposing pressures, so that the two fitting wings 222 abut against and clamp the opposite sides of the fitting projection 11. At this time, the two fitting wings 222 are mutually parallel with respect to the extension direction of the fitting body 22, thereby completing the assembly of the fitting body 22 and the heat insulating strip 1.

As shown in FIGS. 1 and 3, a mounting projection 223 is integrally formed on one side of the fitting body 22 away from the heat insulating strip 1. The main frame 21 is configured with a mounting groove 211 for accommodating the mounting projection 223. The mounting groove 211 is designed as a dovetail groove, and a cross section of the mounting projection 223 is also in a dovetail shape. The mounting projection 223 is embedded in the mounting groove 211 so that the mounting projection 223 is closely fit to a wall of the mounting groove 211, thereby making the main frame 21 abut against and be fixed relative to the fitting body 22. The fitting body 22 is configured with chamfers 224 at the corners on two sides of the mounting projection 223. After the mounting projection 223 enters the mounting groove 211, a solder groove 23 is formed between the fitting body 22 and the main frame 21 through the chamfer 224. The main frame 21 and the fitting body 22 may be selectively reinforced by means of laser micro welding according to differences in use environments or functional requirements of the products. The solder groove 23 is configured to store solder, thereby reducing the impact on the overall flatness of the profile frame 2 after a welding seam is shaped.

### Embodiment 2

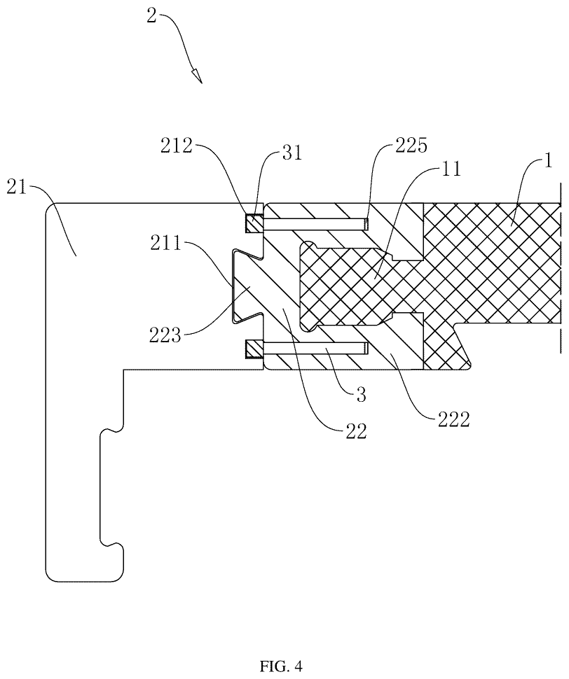

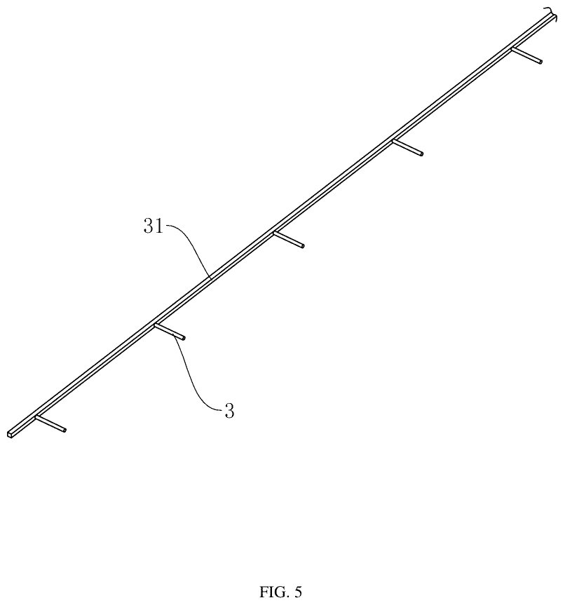

As shown in FIGS. 4 and 5, based on the Embodiment 1, the fitting body 22 in the present embodiment is configured with a plurality of blind holes 225, and the bottoms of the blind holes 225 are provided in the fitting wings 222. Since there are two fitting wings 222, the plurality of blind holes 225 are arranged in two rows, with a single row of blind holes 225 corresponding to one of the fitting wings 222 of the fitting body 22, and the arrangement direction of each row of the blind holes 225 is consistent with a length direction of the fitting body 22. A reinforcing rod 3 is inserted into the blind hole 225, the reinforcing rod 3 is made of stainless steel, and the hardness of the reinforcing rod 3 is greater than the hardness of the fitting body 22 and the hardness of the fitting wing 222. Ends of the reinforcing rods 3 inserted into the single row of blind holes 225 away from the bottoms of the blind holes 225 are fixedly connected to the same connecting rod 31, and the connecting rod 31 is made of the same material as the reinforcing rods 3. When the reinforcing rod 3 is inserted into the blind hole 225, a length direction of the connecting rod 31 is consistent with the length direction of the fitting body 22.

As shown in FIGS. 4 and 5, the length direction of the connecting rod 31 is consistent with the length direction of the fitting body 22. The main frame 21 is configured with two grooves for the connecting rod 212, a length direction of the groove for the connecting rod 212 is consistent with a length direction of the main frame 21, and the two grooves for the connecting rod 212 are respectively positioned on two opposite sides of the mounting groove 211. A single groove for the connecting rod 212 is configured for accommodating one connecting rod 31. After the connecting rod 31 is inserted into the groove for the connecting rod 212, the connecting rod 31 generates a contact force against a wall of the groove for the connecting rod 212 due to the deformable potential energy of the fitting wings 222 relative to the fitting body 22, with the direction of the contact force facing the mounting groove 211, such that the connecting rod 31 receives a reaction force from the groove for the connecting rod 212 so that each reinforcing rod 3 has a tendency to swing towards the fitting groove 221, so the reinforcing rod 3 has a force against deformation on the fitting wings 222, thereby improving the clamping stability of the fitting wings 222 to the fitting projection 11 in an assembled state.

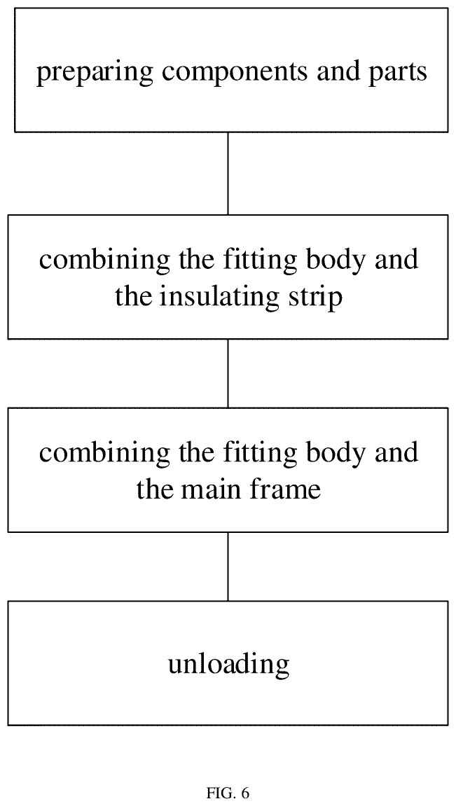

The embodiment of the present application discloses a manufacturing process of the above assembled door and window frame profile. As shown in FIG. 6, the manufacturing process includes the following steps in sequence:
S1: preparing components and parts: manufacturing the main frame 21 and the fitting body 22 respectively, where the fitting body 22 is integrally formed with the fitting wings 222, and in a natural state, the two fitting wings 222 on the fitting body 22 are inclined to each other in opposite directions with respect to an extension direction of the fitting body 22;
S2: assembling the fitting body 22 and the heat insulating strip 1: placing the fitting projection 11 of the heat insulating strip 1 between the two fitting wings 222, and pressurizing the two fitting wings 222 by using a mounting equipment so that the two fitting wings 222 tightly clamp the fitting projection 11;
S3: assembling the fitting body 22 and the main frame 21: connecting the fitting body 22 and the main frame 21 by using the mounting equipment; and
S4: unloading: removing the assembled main frame 21, fitting body 22 and heat insulating strip 1 from the mounting equipment, during which the main frame 21 and the fitting body 22 may be selectively reinforced by welding according to the product requirements.

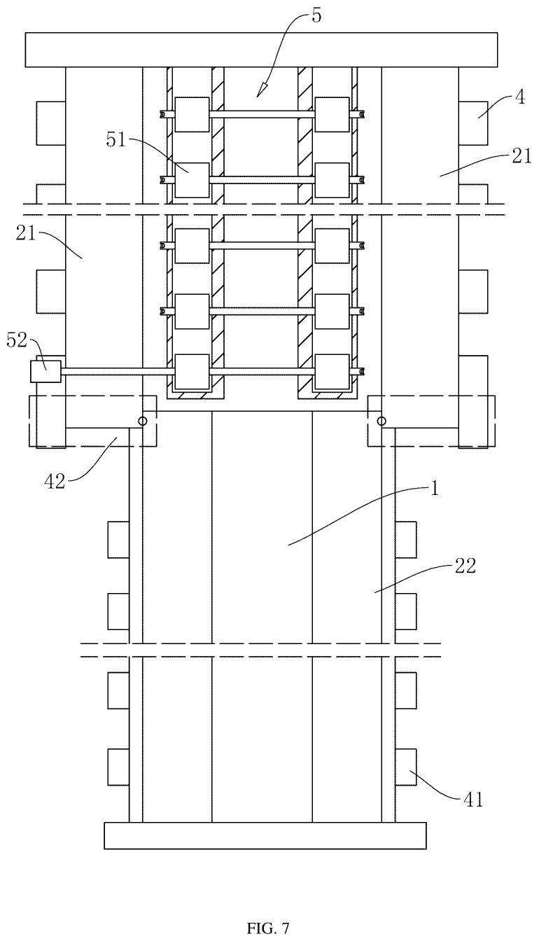

As shown in FIG. 7, the S2 and S3 are carried out simultaneously on the mounting equipment. The mounting equipment includes a stationary shelf 4 and a movable shelf 41, where the movable shelf 41 is positioned on one side of the stationary shelf 4 and is movable relative to the stationary shelf 4 in a horizontal direction. The main frame 21 is placed on the stationary shelf 4, and a length direction of the main frame 21 is consistent with a moving direction of the movable shelf 41. The movable shelf 41 is configured to place the fitting body 22 and the heat insulating strip 1, and to carry the fitting body 22 and the heat insulating strip 1 to move close to the stationary shelf 4. The stationary shelf 4 is provided with a power mechanism (not shown in the figure) for controlling the movement of the movable shelf 41. The power mechanism may be in the form of a gas cylinder, an oil cylinder, a pinion and rack, or any other mechanical structure capable of achieving bidirectional linear motion.

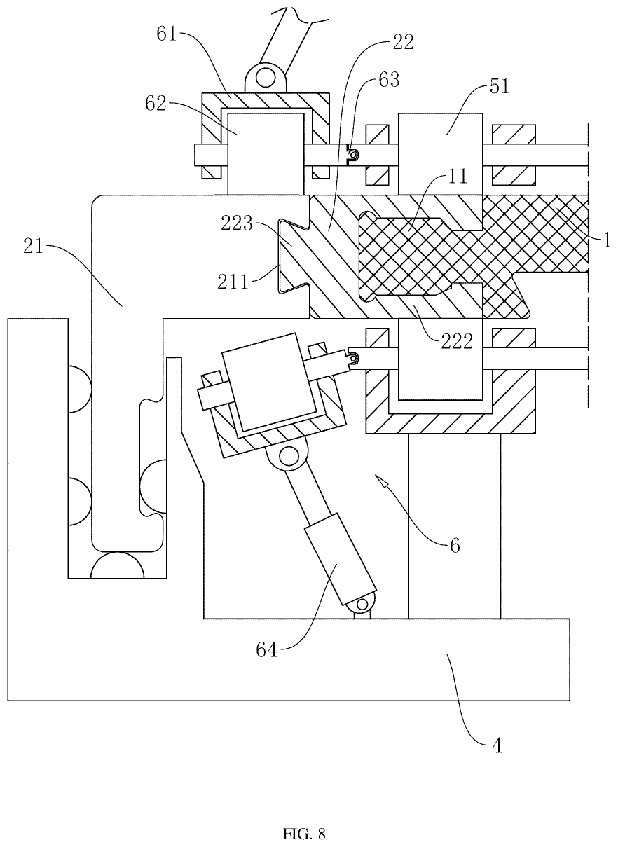

As shown in FIGS. 7 and 8, the length direction of the fitting body 22 on the movable shelf 41 is consistent with the moving direction of the movable shelf 41. The movable shelf 41 moves close to the stationary shelf 4 so that the fitting body 22 moves to a position next to the main frame 21, thereby inserting the mounting projection 223 of the fitting body 22 into the mounting groove 211 of the main frame 21. Since raw materials for the main frame 21 and the fitting body 22 are relatively long, the mounting equipment further includes a rolling mechanism 5 in order to reduce a required displacement of the movable shelf 41. The rolling mechanism 5 includes a drive motor 52 and a plurality of rolling wheels 51, where the rolling wheels 51 are all rotatably connected to the stationary shelf 4, a part of the rolling wheels 51 are positioned above the fitting body 22 and a part of the rolling wheels 51 are positioned below the fitting body 22. Two sets of rolling wheels 51 are provided for a single fitting body 22, each set of which is arranged in a direction along the moving direction of the movable shelf 41, and an axis of each rolling wheel 51 is perpendicular to the length direction of the main frame 21. When the fitting body 22 enters the stationary shelf 4, the two sets of rolling wheels 51 respectively abut against one side of the two fitting wings 222 away from the fitting projection 11, so that the surfaces of the rolling wheels 51 abut against the fitting wings 222 in a rolling manner and applies a thrust thereon, so that the fitting wings 222 are plastically deformed to tightly abut against the fitting projection 11. The drive motor 52 is fixedly provided at a position of the stationary shelf 4 close to the movable shelf 41, and an output shaft of the drive motor 52 is coaxially connected to one of the rolling wheels 51 closest to the movable shelf 41 to control the rotation thereof. Once the rolling wheel 51 connected to the drive motor 52 is in contact with the fitting wings 222, the fitting body 22 and the heat insulating strip 1 receive power from the drive motor 52, and the movable shelf 41 may stop moving.

As shown in FIGS. 7 and 8, the rolling mechanism 5 further includes an unloading assembly 6. After the fitting body 22 is in alignment with the main frame 21 under the drive of the rolling wheels 51, the main frame 21 is in snap-in connection with the fitting body 22. The unloading assembly 6 is configured to remove the assembled main frame 21, fitting body 22, and heat insulating strip 1 from the stationary shelf 4 together. The unloading assembly 6 includes a movable rack 61, where the movable rack 61 is movably connected to the stationary shelf 4, and the movable direction is close to or away from the main frame 21. A plurality of unloading wheels 62 are rotatably provided on the movable rack 61, and a single unloading wheel 62 corresponds to one rolling wheel 51. Except for the rolling wheel 51 connected to the drive motor 52, a universal coupling 63 is connected between an axle of each rolling wheel 51 and an axle of a respective one unloading wheel 62, namely, the rolling wheel 51 and the unloading wheel 62 rotate synchronously at the same speed.

As shown in FIGS. 7 and 8, the present embodiment is described by taking a side wall surface of the main frame 21 being flush with a side wall surface of the fitting body 22 as an example. The movable rack 61 is articulated with the stationary shelf 4, and a hinge axis coincides with a rotation axis of the universal coupling 63 relative to the axle of the rolling wheel 51. A control source 64 for controlling the rotation of the movable frame is provided below the stationary shelf 4. In the present embodiment, the control source 64 is a gas cylinder, a body of the gas cylinder is articulated with the stationary shelf 4, and an end of a piston rod is articulated with the movable rack 61. When the piston rod of the gas cylinder extends out, the movable rack 61 swings in a direction close to the main frame 21. In the moving process of the fitting body 22 relative to the main frame 21, the unloading wheel 62 is not in contact with the main frame 21. After the main frame 21 and the fitting body 22 are docked, the movable rack 61 moves close to the main frame 21 to make each unloading wheel 62 abut against the main frame 21. At this time, when the rolling wheel 51 rotates again, each unloading wheel 62 also rotates accordingly, so as to generate a friction for moving forward on the main frame 21 to move the main frame 21, thereby removing the assembled main frame 21, fitting body 22 and heat insulating strip 1 from the stationary shelf 4 together.

As shown in FIG. 7, the mounting equipment further includes a laser welding torch 42. The laser welding torch 42 is fixed relative to the stationary shelf 4 and is positioned at one end of the stationary shelf 4 close to the movable shelf 41. In the process of unloading, the laser welding torch 42 may be activated as needed to reinforce the main frame 21 and the fitting body 22 by welding.

All of the above are preferred embodiments of the present application, and are not intended to limit the scope of protection of the present application. Therefore, all equivalent changes made according to the structure, shape and principle of the present application should be covered within the scope of protection of the present application.

### LIST OF REFERENCE SIGNS

1 heat insulating strip
11 fitting projection
2 profile frame
21 main frame
211 mounting groove
212 groove for the connecting rod
22 fitting body
221 fitting groove
222 fitting wing
223 mounting projection
224 chamfer
225 blind hole
23 solder groove
3 reinforcing rod
31 connecting rod
4 stationary shelf
41 movable shelf
42 laser welding torch
5 rolling mechanism
51 rolling wheel
52 drive motor
6 unloading assembly
61 movable rack
62 unloading wheel
63 universal coupling
64 control source

What is claimed is:

1. An assembled door and window frame profile, comprising a profile frame connected to a heat insulating strip, wherein the profile frame comprises a main frame and a fitting body, the fitting body is in snap-in connection with the heat insulating strip, and the fitting body is configured to be detachably connected to the main frame.

2. The assembled door and window frame profile according to claim 1, wherein the heat insulating strip is provided with a fitting projection, the fitting body is configured with a fitting groove, and the fitting projection is configured to be embedded in the fitting groove and abut against a wall of the fitting groove.

3. The assembled door and window frame profile according to claim 2, wherein the fitting body is provided with two fitting wings, the fitting groove is formed between the two fitting wings, the two fitting wings are configured to be mutually inclined in opposite directions with respect to an extension direction of the fitting body before the fitting projection enters the fitting groove, and the two fitting wings are configured to be mutually parallel with respect to the extension direction of the fitting body after the fitting projection enters the fitting groove.

4. The assembled door and window frame profile according to claim 3, wherein the main frame and the fitting body are configured to be in snap-in connection with each other, the main frame is configured with a mounting groove, the fitting body is provided with a mounting projection, and the mounting projection is configured to be embedded in the mounting groove and abut against a wall of the mounting groove.

5. The assembled door and window frame profile according to claim 4, wherein the fitting body is provided with a chamfer, so that a solder groove is formed between the fitting body and the main frame through the chamfer after the mounting projection enters the mounting groove.

6. The assembled door and window frame profile according to claim 4, wherein the fitting body is configured with a plurality of blind holes, an opening of each of the plurality of blind holes is positioned on one side of the fitting body away from the two fitting wings, bottoms of the plurality of blind holes are positioned in the two fitting wings, a reinforcing rod is inserted into each of the plurality of blind holes, and a hardness of the reinforcing rod is greater than a hardness of the fitting body and a hardness of the two fitting wings, and
the plurality of blind holes are arranged in a length direction of the fitting body, ends of the plurality of reinforcing rods arranged in the length direction of the fitting body away from the bottoms of the plurality of blind holes are fixedly connected to one connecting rod, a length direction of the connecting rod is parallel to the length direction of the fitting body, a groove for the connecting rod is formed in the main frame, a length direction of the groove for the connecting rod is parallel to a length direction of the main frame, the connecting rod is positioned in the groove for the connecting rod, and the connecting rod is configured to abut against a wall of the groove for the connecting rod.

7. A manufacturing process of the assembled door and window frame profile according to claim 3, comprising following steps in sequence:
S1: manufacturing the main frame and the fitting body respectively, wherein the fitting body is integrally formed with the two fitting wings, and in a natural state, the two fitting wings on the fitting body are mutually inclined in opposite directions with respect to the extension direction of the fitting body,
S2: placing the fitting projection of the heat insulating strip between the two fitting wings, and pressurizing the two fitting wings by using mounting equipment so that the two fitting wings clamp the fitting projection,
S3: connecting the fitting body and the main frame by using the mounting equipment, and
S4: removing the main frame, the fitting body and the heat insulating strip assembled from the mounting equipment.

8. The manufacturing process of the assembled door and window frame profile according to claim 7, wherein the step S2 and the step S3 are carried out simultaneously on the mounting equipment, the mounting equipment comprises a stationary shelf, a movable shelf and a rolling mechanism, the rolling mechanism is positioned on the stationary shelf and comprises a plurality of rolling wheels, the plurality of rolling wheels are rotatably connected to the stationary shelf, the main frame is placed on the stationary shelf, an axis of each of the plurality of rolling wheels is perpendicular to a length direction of the main frame, the movable shelf is slidable relative to the stationary shelf with a sliding direction being parallel to the length direction of the main frame, the movable shelf is configured to apply a thrust on the fitting body and the heat insulating strip as the movable shelf moves, so as to move the fitting body and the heat insulating strip, and during the movement of the fitting body and the heat insulating strip, the two fitting wings abut against surfaces of the plurality of rolling wheels in a rolling manner.

9. The manufacturing process of the assembled door and window frame profile according to claim 8, wherein the stationary shelf is provided with a drive motor, and the drive motor is configured to control a rotation of one or more of the plurality of rolling wheels, and
the rolling mechanism further comprises an unloading assembly, the unloading assembly comprises a movable rack, a plurality of unloading wheels are rotatably provided on the movable rack, the movable rack is movably connected to the stationary shelf with a moving direction being close to or away from the main frame, each of the plurality of unloading wheels corresponds to a respective one of the plurality of rolling wheels, a universal coupling is connected between an axle of each of the plurality of unloading wheels and an axle of the respective one of the plurality of rolling wheels, and the unloading assembly further comprises a control source for controlling a movement of the movable rack.

10. The manufacturing process of the assembled door and window frame profile according to claim 9, wherein the step S4 further comprises welding the main frame and the fitting body, the mounting equipment further comprises a laser welding torch, and the laser welding torch is fixed relative to the stationary shelf and is positioned at one end of the stationary shelf close to the movable shelf.
